(19) United States
(12) Patent Application Publication
(10) Pub. No.: US 2003/0141093 A1
(43) Pub. Date: Jul. 31, 2003

(54) System and method for routing a media stream

(76) Inventors: Jacob Tirosh, Ramat Hasharon (IL); Haim Zlatokrilov, Haifa (IL); Gil Rotgold, Givataim (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 09/998,913

(22) Filed: Dec. 3, 2001

Related U.S. Application Data
(60) Provisional application No. 60/256,939, filed on Dec. 21, 2000.

(51) Int. Cl. H01B 3/00

(52) U.S. Cl. 174/72 A

(57) ABSTRACT

The present invention is a system and method for routing a media stream. As part of the present invention there is a configurable dynamic router which may receive a media stream and may select an output path from a set of possible output data paths based on network traffic conditions and on service level information associated with the media stream's source. A network management unit may reconfigure the router such that tile set of possible output paths is changed in accordance with traffic conditions throughout the network. The dynamic router may simultaneously transmit the same packet on multiple data paths.

### RELATED APPLICATIONS

This patent application is a continuation-in-par application from U.S. provisional patent application Ser. No. 60/256,939, filed on Dec. 21, 2000 and hereby incorporated by reference in its entirety.

### FIELD OF THE INVENTION

The invention relates generally to the field of routing communications in a distributed data environment. More specifically, the present invention relates to a method and a system for routing and maintaining quality of service for a media stream through a heterogeneous or partially unregulated network.

### BACKGROUND OF THE INVENTION

The proliferation of high bandwidth network equipment has facilitated expanded use of bandwidth intensive applications in general, and real time streaming data applications, such as V²oIP (Voice/Video over Internet Protocol), in particular. Although some present day networks may have sufficient bandwidth and are properly configured to carry streaming media, they are for the most part unable to distinguish between conventional data packets and data packets comprising a “Real Time” (“RT”) media streams. Media stream packet or packets, traveling from their source to heir destination, may be routed across more than one network, where each network may be owned and/or operated by a different party and may have different transmission characteristics. Therefore, a media packet may inadvertently be routed through a path or paths having insufficiently high throughput to maintain a desired quality of service for the media stream. Present day networks and network routing equipment, in particular I.P. networks, are inefficient at directing, routing or handling RT media streams which may require handling different than that for non-RT media stream data. Present day routing systems are unable to adjust routing paths in session such that a quality of service is maintained across multiple heterogeneous networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects features, and advantages thereof, may best be understood by reference to the following detailed description when read with the accompanying drawings in which:

FIG. 1 is a diagram showing a media stream routing system according to the present invention;

FIG. 2 is a diagram showing the paths of media streams as routed through the system according to the present invention;

FIG. 3 is a block diagram showing the functional modules of a configurable router according to the present invention;

FIG. 4 is a block diagram of a network management unit according to the present invention;

FIG. 5 provides a flow-diagram of a call set-up procedure according to the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

The present invention is a system and method for routing a media stream. As part of the present invention there is a dynamic router which may receive a media stream and may select an output path from a set of possible output data paths. A network management unit or quality of service (“QoS”) management system may dynamically update the dynamic router such that the set of possible output paths is changed to attain a target quality of service level. The dynamic router may switch from one output path to another path. The router may switch paths to maintain a QoS level or may, or the dynamic router may simultaneously transmit along two or more paths.

### DETAILED DESCRIPTION OF THE INVENTION

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus,

The processes and displays presented herein are not inherently related to any particular computer or other apparatus. Various general purpose systems may be used with programs in accordance with the teachings herein or it may [symbol] construct a more specialized apparatus to perform [symbol] desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The present invention is a system and method for routing a media stream. As part of the present invention there is a dynamic router which may receive a media stream and may select an output path from a set of possible output data paths. The output paths may pass through network segments operated by third parties and whose transmission characteristics are not known. Intermediate routers may receive and retransmit media stream packets, either to another intermediate router or to a dynamic router correlated to the media stream's destination. The routers may be separated by network segments having unpredictable transmission characteristics.

A network management unit or quality of service (“QoS”) management system may dynamically update the dynamic router such that the set of possible output paths is changed. The change may be done manually, automatically, semi-manually or otherwise. The change in output paths may be initiated to attain a target quality of service level. The dynamic router may switch from one output path to another path. The router may switch paths to maintain a QoS level or may switch for another reason such as to save money by switching to a data path having a lower associated cost or such as for traffic engineering purposes. The rules for switching the path may or may not be part of the operator policy. The dynamic router may also simultaneously transmit the same data packets along two or more paths.

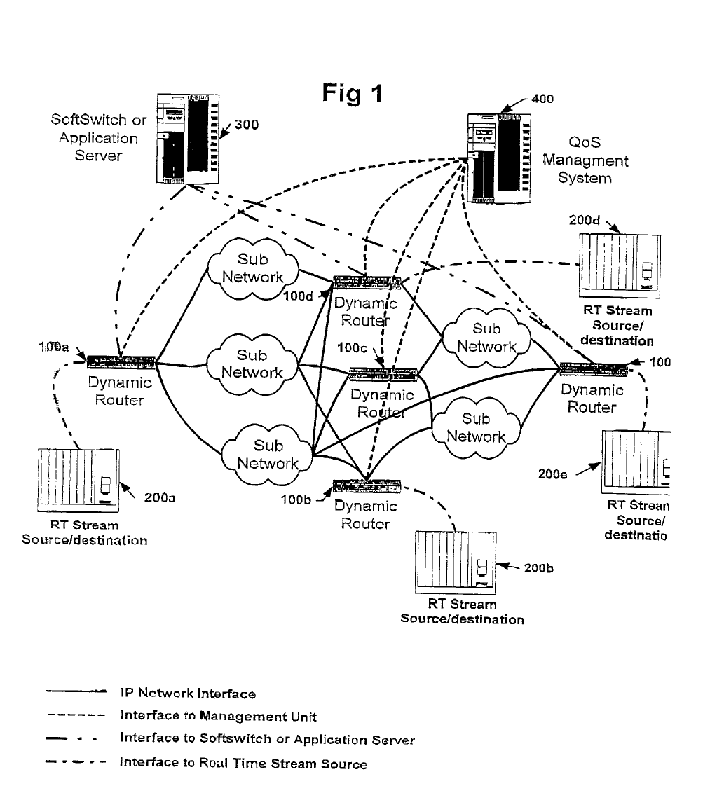

Turning now to FIG. 1, there is shown a media stream routing system according to the present invention. Dynamic routers 100a through 100e may receive and transmit media stream data through sub-networks or network segments provided by data network operators such as MCI, QWEST, or AT&T. The sub-networks are IP (Internet Protocol) based, and thus may or may not be provided with good quality of service mechanisms and controls. For any sub-network the owner/operator of the routing system of the present invention may or may not have control on the performance degradation (e.g. packet delay, jitter, loss and others) experienced by the stream upon traversing a sub-network or on the bandwidth available for the applications on the sub-network. Media stream packets originating at RT Stream Source 200a may pass through one or more sub-networks on the way to their RT Stream Destination, for example 200d. A router through which a data stream enters the routing system of the present invention is called an ingress router. While a router from which a media stream leaves the system is referred to as an egress router. Dynamic routers in between an ingress router and an egress router, trough which a media stream may be routed, are referred to as Intermediate routers or forwarding routers. Note that the same physical router may be denoted ingress router for some media streams, egress router for some other media streams, and intermediate router for yet some other streams.

Network performance parameter measurements such as packet delay (latency) and packet loss may be taken between the ingress and egress points of a media stream. For example, a media stream originating at RT Stream Source 200a may enter the network at dynamic router 100a, the stream's point of ingress. If the stream's destination is RT Stream Destination 200e, it will leave the network at router 100e, the stream's point of egress. A measurement of the delay, jitter, packet loss,available bandwidth and other performance measures between the system's points of ingress and egress may be conducted by routers 100a and 100e. Measuring network parameters is well known and any method known today or which may be developed in the future is applicable to the present invention. Computation of Quality of Service measures (such as MOS) derived from these measures may be conducted as well.

The dynamic routers may also conduct measurements of network performance parameters across individual sub-networks, either between neighboring dynamic routers or between non-neighboring routers. Routers of the present invention are called neighboring if they communicate with each other without having their traffic passing other routers of the present invention. Values such as delay, jitter, packet loss, available bandwidth and others may be measured across each sub-network. Computation of Quality of Service measures (such as MOS) derived from these measures may be conducted as well. The quality of service related information may be transmitted to a network management unit or system which may also be referred to as a quality of service (“QoS”) management system 400. A QoS management system 400 may receive measurement data from the dynamic routers 400 regarding tie quality across the individual sub-networks, the occupancy at the individual dynamic router nodes and may instruct the dynamic routers where to route media stream data traffic. The system 400 may reside on a separate computing unit or may consist of software modules executed on processors within one or more of the dynamic routers.

A soft-switch or application server 300 may be provided as part of the present invention. The soft-switch 300 may interface with a dynamic router 200 and a QoS system and may provide information relating to a destination I.P. address and port number for a media stream, a required quality of service level for the stream, and other information relating to routing the stream through the system of the present invention. The soft-switch 300 may facilitate a connection between a media stream source and destination by instructing the real-time stream source which destination I.P. address to put on the media stream in order to have it pass through the routing system of the present invention. The soft-switch 300 may direct the stream to pass through the dynamic router (400) system of the present invention by Instructing the real-time stream source to put the IP address of the ingress dynamic router on the media stream, The soft-switch 300 may correlate a media stream with a specific account and/or application being used by an account based on the stream's source I.P. address) port number and/or other identifying information (e.g. data tags) in the streams data packets. The soft-switch 300 then correlates the identifying information with a set of transmission parameters such a required qualify of service level, The soft-switch provides the information to die system such that the media stream from the identified source is routed according to its required transmission parameters.

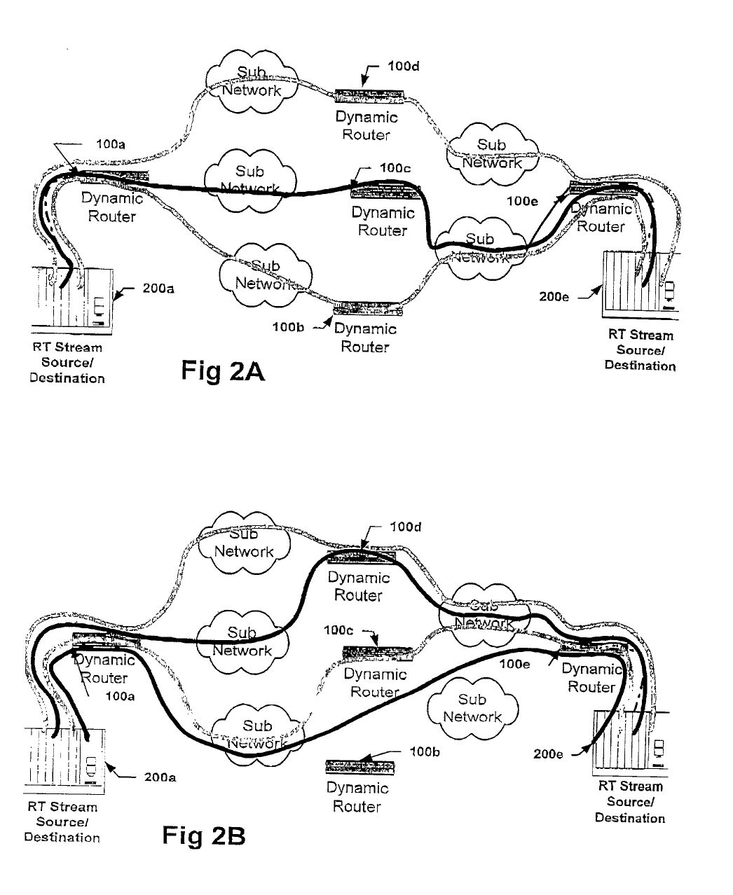

Turning now to FIGS. 2A & 2B, there are shown illustrations of the routing system of the present invention in operation. The route of each media stream starts at a RT stream source and ends at an RT stream destination. An RT stream source may also be an RT Stream destination in the event of bi-directional communication. Any I.P. enabled communications device, including a computing device with multimedia capabilities, may be an RT Stream Source/Destination. In certain circumstances, when an I.P. gateway is used to convert a non-I.P. signal into I.P. packets, the gateway may be considered the RT Stream Source/Destination. For purposes of this disclosure, however, we refer to a gateway as a separate entity from the original source of destination of a communications signal which may be converted into a RT media stream to be routed through the routing system of the present invention.

Regardless of the source or destination, an RT media stream passes through one or more sub-networks where the dynamic touter entities are used to force the route to pass between the sub-networks desired by the system. For each one-directional stream the first dynamic router it crosses is called the ingress dynamic router and the last dynamic router it passes is called the egress dynamic router. The ingress dynamic router receives the stream from the RT stream source and the egress dynamic router delivers it to the RT stream destination. Typically, the system can lay more than one path between the ingress dynamic router and the egress dynamic router. FIG. 2A shows a media stream, illustrated as a dark line, originating at RT Stream Source 100a, passing through ingress router 100a, intermediate router 100c, egress router 100e, and arriving at RT Stream Destination 200e. In addition to the actual media stream data path, there is also shown two alternate data paths from source to destination, each path illustrated by a light colored line. The alternate routes allow the ingress dynamic router to perform in session switching of data traffic from one route to another. A dynamic router may switch routes or paths in response to many events, including the noticing of a change of quality/conditions along any of the paths. The alternate data paths may carry probe packets. The probe packets may be sent from the ingress router 200a to tie egress router 200e in order to determine the transmission characteristics along the alternate paths. In the event that the quality of transmission along the first data path falls below a minimum threshold defined for that particular session, the ingress dynamic router may reroute the media stream along one of the alternate paths. The rerouting may not require the intervention of the QoS management system, since the routes may already precomputed and reconfigured in the router and set over the network.

FIG. 2(B) depicts a scenario in which the set of routes between the source and destination is changed. This change may be done at the initiative and control of the QoS management system which may receive data relating to transmission quality across various sub-networks used by the system and may determine that there are, more suitable (e.g. less expensive, better transmission characteristics, between quality for the money, etc.) routes available than that ones being used by the dynamic routers at that moment. The routes may be reset in the middle of a media session or between sessions. As FIG. 2B illustrates, a media stream from source to destination may travel along one path, while a return media stream from the destination to the source may travel along another path.

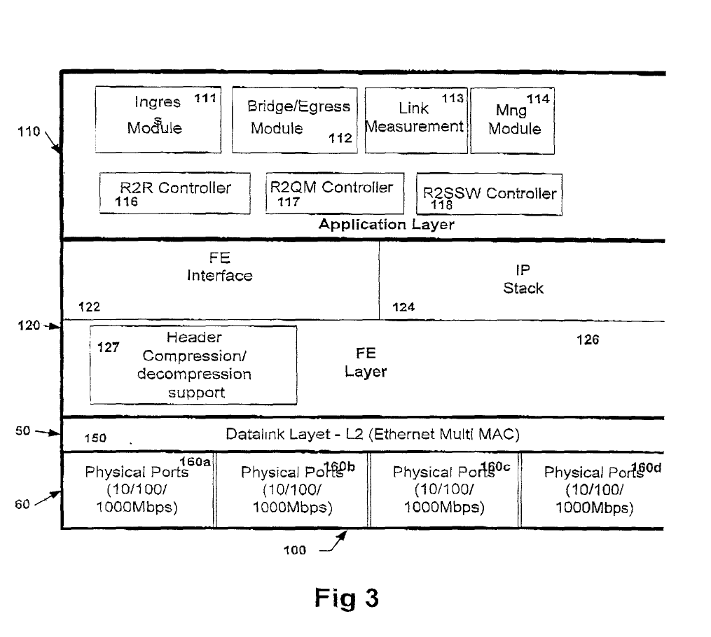

Turning flow to FIG. 3, there is shown an example of an architecture for a configurable dynamic router which may be used as part of the present invention. The router may have a four-layer architecture: a) an application layer, b) a forwarding layer, c) a datalink layer, and d) a physical layer.

As the name suggests, the forwarding layer may forward a media stream packet to a downstream router or to the stream's final destination. A dynamic router may force the packet to be forwarded to the desired next-hop dynamic router (also referred to as the next down stream dynamic router) or to the stream's final destination through a specific sub-network, by placing on the packet the IP address of the next-hop dynamic-router and sending it into the proper sub-network. Thus, each dynamic-router on the path places on the packet the IP address of the next-hop dynamic router before it sends it on the proper sub-network. Further route enforcement (forcing the packet to go through specific sub networks) is achieved by a proper setting of the IP address(es) of the next hop (down steam) dynamic router. In the event that the down stream dynamic router is connected to two or more sub networks then a specific IP address may be set up for each sub network it is connected to; for example if it is connected to Network A and network B, then on its connection to Network A it will use (and advertise) an IP address belonging to Network A and on its connection to Network B it will use an IP address belonging to Network B. This mechanism combined with having the upstream dynamic router placing on the packets the proper IP address (the upstream dynamic router uses a Network A address of the downstream dynamic router when placing the packet on Network A) is likely to cause the sub network to forward the packet directly to the downstream dynamic router and not indirectly via other sub networks. Thus, using these mechanisms the system of dynamic routers can force that with high likelihood the packets will cross only the sub networks (follow the path) it chose. The forwarding process may include receiving the packet, differentiating the packet from packets belonging to other streams (e.g. either by port number or by some other means such as a tag), and analyzing the packet's nature or payload. In the event the packet is an ingress packet, the packet may receive one or more additional tags (added to the RTP payload). The tags may include the destination I.P. address and port, path ID, and set of flags. The tag may contain the I.P. addresses of routers through which the packet may pass, thereby facilitating the forwarding of the packet by downstream routers (layer 5 tunneling). In this case the tag inserted at the ingress router may contain an I.P. address map for the packet to follow from the ingress router, through one or more possible intermediate routers and finally to the egress router. Alternatively, a path is first opened by telling all dynamic routers on the path their downstream dynamic router and associating with the path a unique label which is advertised to the dynamic routers on the path. In this case the tag may consist of the unique label only. Data within a tag inserted at the ingress router may provide the egress router with information as to the I.P. address and port number of the RT Stream destination of the packet. Ingress packets may also be treated for header compression by header compression module 141.

The connection of the dynamic router to one or more sub networks may be done by connecting the dynamic router interface (or interfaces) to a switch (or a hub) which connects to routers/gateways residing on the different networks. The forwarding of a packet to the proper sub network (proper gateway) can be done by placing a proper MAC address (of the corresponding gateway) on the packet and delivering the packet to the switch; this will cause the switch to direct the packet to the proper sub network (proper router). This allows one to avoid restricting itself to dedicate a physical interface to the traffic directed to a single sub network; rather, one can use the same physical interface to direct traffic to two sub networks. The mechanism thus allows one to use a single physical interfaces as multiple logical interfaces (or MAC level interfaces) to direct traffic to multiple sub networks.

The traffic entering the dynamic router may be routed to the dynamic router using the declared IP addresses of the physical interfaces. An IP address must be uniquely associated with a single interface (while an interface can have more than one IP address associated with it).

Egress packets may be treated to erase or strip the tags inserted at an ingress router and forwarded to the proper termination IP address on the proper UDP port (as designated in its tags). The egress router may also defragment packets aggregated by the header compression module 141. Packets that are designated to another router (as could be derived from the QoS tag) are subjected to IP address swapping (implementing layer 5 tunneling), and then transmitted to the correct destination (through the correct physical interface).

The forward layer may manage the physical interfaces, 160a through 160d, the datalink layer, and may also provide communication services to the application layer. Information from the application layer, such as configuration information and other messages, may be pushed using the forwarding layer interface 122 and IP stack modules 124.

The application layer may handle such functions as decision making relating to session opening, assigning tags to sessions, in-session switching (re-routing), managing a call setup process, accounting of consumed bandwidth, and various configuration and policy specification. The Bridge/Egress module 112 may manage the opening of tags (as a bridge and Egress), configuration and setting of the forwarding layer parameters.

The link measurement module 113 may monitor the quality of each link (end-to-end tag, or point-to-point link). It may generate a probing stream for measurement of transmission quality over a sub-network(s) which may or may not currently be in use for transmission of a data stream, or it may configure information (time stamp) in a tag on a media stream data packet in order to measure transmission quality over a data path being used. Measurement of network transmission parameters is well known, and any method currently known or to be developed in the future is applicable to the present invention. The link measurement module's 113 outputs may be provided to the ingress router and to the QoS management system.

The various controllers may be responsible for communication and specific activities related to their controlled entities. The R2R controller 116 may handle communications with other dynamic routers, the R2QM controller 117 may handle communications with the QoS management system, and the R2SSW controller 118 may handle communications with the soft-switch or application server for both billing and call setup procedures.

The management module 114 may handle the interface or communication with a configuration and management system for coordination of high availability and general management and monitoring tasks.

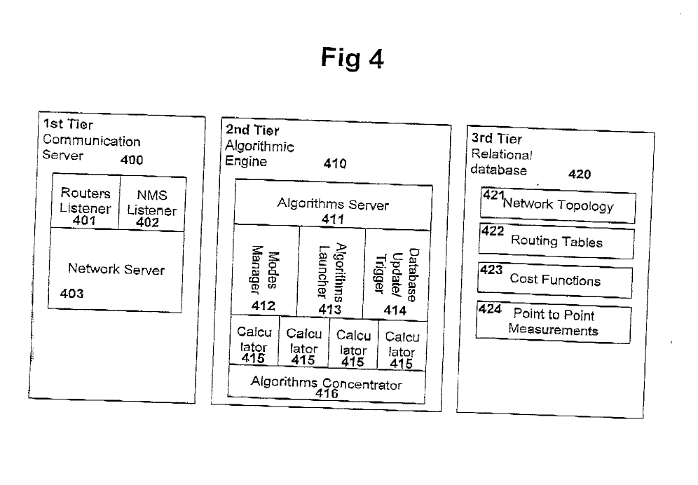

Turning now to FIG. 4, there is shown a block diagram of a QoS or network management system which may be used as part of the present invention. The system may have a 3 tier architecture, where the first tier 400 may perform all the communication functions with the outer world, the second tier 410 may perform all algorthimic functions, and the third tier 730 may store the system knowledge in a database.

The network (QoS) management system may either be centralized, that is residing on a sinle computing unit, or it may be distributed across several processing units.

The first tier 400 may have a “router listener” entity 401, a “NMS listener” entity 402, and a network server module 403. The router listener 401 may accept messages from the configurable routers. Such messages could be updates regarding network conditioins, performance or topology, status messages regarding availability of routers, switching information, and any other information relevant to the operation of the present invention.

The NMS listener 402 accepts messages from a network management and configuration system, which system may perform such basics as faults tracking, configuration setting, accounting, performance monitoring and security. It may allow the enforcing of operator policies regarding various system capabilities (e.g. setting manual routes, setting service lever agreement (“SLA”) thresholds, etc.), it may constantly monitor system faults, and it may include an interface that allows the data provided by the invention to be visualized to the operator.

The network server 403 may facilitate communications of the QoS with the outer world through the above mentioned listeners and an internal communications module for transmitting messages to the routers and other network elements.

The second tier 410 may consist of an Algorithms server 411, modes manager 412, algorithmic launcher 413, database maintenance module 414, various calculating entities 415, and an algorithms concentrator 416. The algorithms server 411 is the managing entity of the second tier. It may receive inputs from the first tier and may manage the reactive rerouting process. The modes manager 412 supports the implementation of manual modes to generate routes (manual, semi manual whereas the system suggests a route to the operator and the later approves or edit it, and automatic mode, whereas the system finds routes by itself. The algorithnic launcher 413 may schedule the launch of an algorithm calculating entitie 415, manage their distributed implementation and input view of the database The database maintenance module 414 may constantly update the database and identify various possible triggers that should initiate some corresponding activities. Triggers could include the change of status of one of the configurable routers, or a new measured transmission value on one of the sub-networks or segments. The calculating entities 415 could perform parallel and/or sequential implementation of numerous algorithms. Those are used for example to perform least cost routing, shortest path routing, identifying alternative routes, traffic engineering. The concentrator 416 may receives the various results of the calculating entities 415 and check that there is no cross interference, and may update both the database and the configurable routers with the results.

The third tier 420 is the database that contains various tables relating to the overall system. The tables may contain information relating to the network topology 421, routing tables of tags 422, cost input tables 423, and the results of the router-to-router measurements 424, together with many other tables representing various parameters of the network according to tile present invention

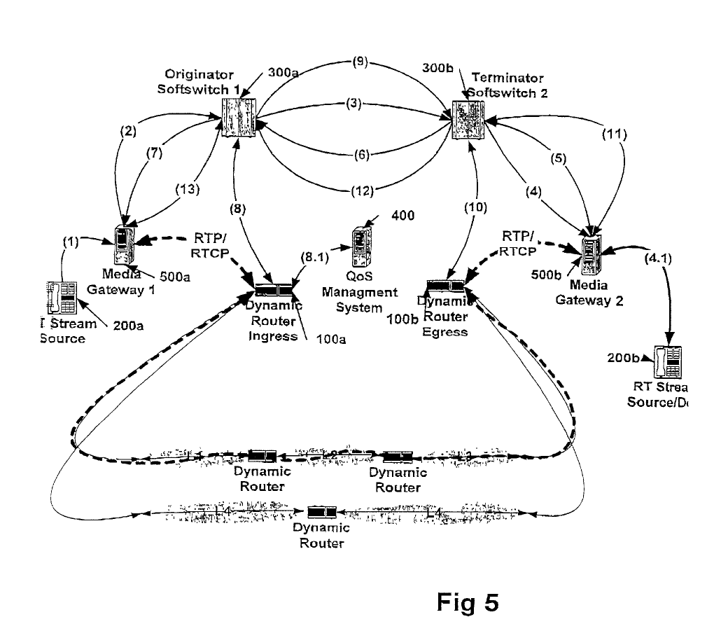

Turning now to FIG. 5, there is shown an embodiment of the system of the present invention with two soft-switches, 300a and 300b, and two gateways, 500a and 500b. The gateways may convert traffic originating at a public switched public telephone network (“PSTN”) into I.P. data traffic or media streams. Circuit switched to packet switched (I.P.) gateways are well known. FIG. 5 illustrates one possible approach for establishing a media stream connection from the RT Stream Source 200a to the RT Stream Destination 200b, using the following steps (note that we describe here the call setup of a one way communications; the set-up of a two way communications can be done similarly):

(1), (2) a call-setup may be initiated by the RT stream source 200a and may be transferred to the originator soft-switch 300a via the originator media-gateway 500a.

(3) The originator soft-switch 300a may forward the call set-up to the terminator soft-switch 300b (perhaps after routing it via other soft-switches). At this point the terminator soft-switch 300a may determine the service level (SL) of the call recipient and may assign the associated SL to the call (this could be done earlier by the originator soft-switch as a function of the SL requested by the call originator).

(4) The terminator soft-switch 300b may issue a setup command to the terminator media gateway 500b (and the call recipient (4.1)).

(5) The terminator media gateway 500b may issue a connect command to the terminator soft-switch 300b.

(6) The terminator soft-switch 300b may send a connect message with the SL to the originator soft-switch 300a.

(7) The originator soft-switch 300a may issue the connect command (with the address of the terminator media gateway) to the originator media-gateway 500a, which may trigger the originator to start sending the media stream directly, via the internet, to the terminator media gateway 500b. (and not through the routing system of the present invention yet). Following this step, the system may enter into a second protocol phase in which the proper path for the media stream is set at the dynamic router system. At the end of this phase tie stream is being directed through the dynamic router system.

(8) The originator soft-switch 300a may notify the originator or ingress dynamic router 100a (which is the dynamic router adjacent to the originator media gateway) about the call and its associated service level (SL).

(8.1) The originator dynamic router 100a consults, if necessary, with the QoS management system regarding the path that may be taken between the originator dynamic router 100a and the terminator dynamic router 100b.

(9) The originator Soft-switch 300a may send an update message to the terminator soft-switch 300b informing it of the SL of the stream.

(10) The terminator soft-switch 300b may inform the terminator dynamic router 100b about the call, its SL and about the terminator media gateway. This may dictate to tie terminator dynamic router how to direct the stream that will come from the QoS system to the proper media gateway.

(11) The terminator soft-switch 300b may send the update message to the terminator media-gateway 500b. The terminator media-gateway 500b may react by sending the terminator soft-switch 300b an update acknowledgment.

(12) The terminator soft-switch 300b may send back to the originator soft-switch 300a the update acknowledgment (with the SL).

(13) The originator soft-switch 300a may send the update message to the originator media gateway 500a, informing it to direct its out-going stream to the originator dynamic router 100a, rather than to the terminator media gateway 500b. At this point the originator media-gateway will direct the stream through the dynamic router system.

It will be appreciated by persons skilled in the art, that the present invention is not limited by what has been particularly shown and described herein above. Rather the scope of the invention is defined by the claims that follow:

What is claimed:

1. A system for routing a media stream comprising:
a. a first dynamic router and a second dynamic router operatively connected by two or more possible parallel data paths, where each data path is comprised of one or more network segments, said first dynamic router adapted to receive the media stream and to select all output data path from the two or more possible data paths;
b. a network management unit operatively connected said first and second routers and adapted to dynamically update said dynamic routers such that the set of possible data paths is changed; and
c. a database unit adapted to store service parameters relating to one or more media stream accounts, wherein said first dynamic router selects an output path for the media stream based on traffic conditions on the possible output paths and on the service parameters relating to the stream's associated account.

2. The system according to claim 1, wherein at least one of said routers is adapted to determine data traffic conditions on one or more of the possible data paths.

3. The system according to claim 2, wherein said routers are adapted to transmit a probe packet along one or more of the possible data paths.

4. The system according to claim 3, wherein said routers are adapted to receive and analyze a probe packet to determine network conditions between the probe packet's source and destination.

5. The system according to claim 4, wherein said routers are adapted to substantially simultaneously transmit a data packet along two separate paths.

6. The system according to claim 4, wherein the network management unit is adapted to determine data traffic conditions across one or more segments throughout the network.

7. The system according to claim 6, wherein the network management unit dynamically updates said routers based on information relating to data traffic conditions across one or more segments throughout the network.

8. The system according to claim 7, further comprising a gateway operatively connected to said router.

9. The system according to claim 5, wherein said second router is adapted to receive identical packets substantially simultaneously transmitted over more than one path and to combine the packets.

10. The system according to claim 2, further comprising an intermediate router residing between two network segments on a data path between said first and second routers.

11. The system according to claim 2, further comprising a softswitch adapted to direct a media stream source to either said first router or to an alternate IP address.

12. The system according to claim 11, wherein the alternate IP address is the IP of the media stream's destination.

13. The system according to claim 12, wherein said first router inserts a label into a data packet of the media stream identifying a target path for the packet.

14. A method of routing a media stream through one of a plurality of parallel paths, where each path is comprised of one or more network segments, said method comprising routing the media stream through one out of a set of possible data paths between the media stream's source and destination, such that the set of possible paths is selected based on data traffic conditions across one or more segments on the network and the one path selected is selected as a function of data traffic conditions on the set of possible paths and on service parameters associated with the media stream's account.

15. The method according to claim 14, further comprising sending probe packets along the possible paths.

16. The method according to claim 14, comprising sending a data packet along more tan one path to produce multiple corresponding packets.

17. The method according to claim 16, comprising receiving and combining multiple corresponding packets.

18. A dynamic router comprising two or more interfaces, each said interface adapted to be connected to a separate network segment, a communications unit adapted to receive information relating to data traffic conditions on one or more of the network segments, and a forwarding unit adapted to readdress received data packets and to forward the data packets to an interface selected as a function of data traffic conditions on the network segments and on service parameters associated with the data packet's account.

19. The dynamic router according to claim 18, wherein the dynamic router is adapted to switch a media stream between two interfaces during a media stream session.

20. The dynamic router according to claim 19. further comprising a router listener.
